(19) United States
(12) Patent Application Publication
(10) Pub. No.: US 2007/0239984 A1
(43) Pub. Date: Oct. 11, 2007

(54) METHOD FOR TRANSFERRING PARAMETERS BY NETWORK

(76) Inventor: Yu-Ming Lang, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/164,666

(22) Filed: Dec. 1, 2005

(30) Foreign Application Priority Data
Dec. 3, 2004 (TW) 093137368

(51) Int. Cl. H04L 9/00

(52) U.S. Cl. 713/167

(57) ABSTRACT

A method for transferring parameters by network, the method comprising the step of: generating a secret-key and a cryptograph randomly; affording an information transferring side (10) for transferring parameters and data; affording an information receiving side (20) for receiving the parameters and the data; generating the parameters and the data which will be transferred to the information receiving side by network (30); using the cryptograph and an original MAC to encrypt the parameters, transferring the encrypted parameters and the data to the information receiving side by the network; receiving the encrypted parameters transferred back from the information receiving side (20).

### FIELD OF THE INVENTION

The present invention relates to a method for transferring parameters, particularly to a method for transferring parameters by network.

### DESCRIPTION OF RELATED ART

In today's information age, communication networks are becoming ever more pervasive as more and more communication consumers utilize on-line services to access information over the communication network. When the consumers upload or download some important information, viruses easily raid the consumers' computers. Encryption technology is often used to prevent the viruses from attacking the computers and secure the communication network.

Presently, there is a method for transmitting secret information to a client over a communication network. The method includes the steps of: dividing the secret information into a predetermined number N shares using a threshold encryption scheme such that at least a predetermined minimum number M shares, but no more than the predetermined number N shares, are needed to reconstruct the secret information using the threshold encryption scheme; and transmitting to the client a plurality of messages including at least one share in each of said plurality of messages.

However, the present method only transmits the secret information to the client over the communication network. If network-equipment merchants or the consumers need to transfer an important parameter, for example, a path for an user to upload the files to the network-equipment merchants, which needs to be kept confidential, the present method can not insure the parameter's security.

Therefore, what is needed is a method for transferring parameters by network, by which the important parameters can be transferred in security.

### SUMMARY OF INVENTION

A method for transferring parameters by network in accordance with a preferred embodiment of the present invention includes the steps of: generating a secret-key and a cryptograph randomly; affording an information transferring side for transferring parameters and data; affording an information receiving side for receiving the parameters and the data; generating the data which will be transferred to the information receiving side by network; determining if it is necessary to transfer the parameters to the information receiving side; using the cryptograph and an original MAC (Massage Authentication Code) to encrypt the parameters to be encrypted parameters, if it is necessary to transfer the parameters to the information receiving side; transferring the encrypted parameters to the information receiving side by the network; transferring the data to the information receiving side by the network; determining if receiving the encrypted parameters transferred back from the information receiving side; using the secret-key to decipher the encrypted parameters, if receiving the encrypted parameters transferred back from the information receiving side; using the deciphered parameters to have a message digest operation with the cryptograph; figuring out a new MAC; judging if the new MAC is the same to the original MAC; and applying the deciphered parameters, if the new MAC is the same to the original MAC.

Other systems, methods, features, and advantages of the present invention will be or become apparent to one with skill in the art upon examination of the following drawings and detailed description.

### BRIEF DESCRIPTION OF DRAWINGS

FIG. 1 is a schematic diagram of hardware configuration of a system for transferring parameters by network in accordance with a preferred embodiment of the present invention;

FIG. 2 is a flowchart of a preferred method for transferring parameters by network of the system of FIG. 1.

### DETAILED DESCRIPTION

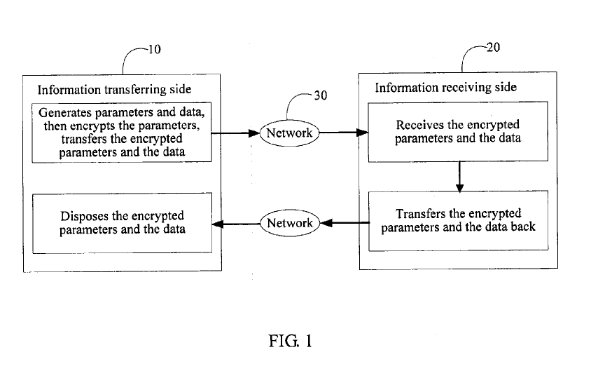

FIG. 1 is a schematic diagram of hardware configuration of a system for transferring parameters by network (hereinafter, “the system”) in accordance with a preferred embodiment of the present invention. The system includes an information transferring side 10, an information receiving side 20, and network 30. The information transferring side 10 generates parameters and data, then encrypts the parameters, and transfers the encrypted parameters and the data to the information receiving side 20 by the network 30. The information receiving side 20 receives the encrypted parameters and the data, and then transfers the encrypted parameters and the data back to the information transferring side 10 by network 30. The information transferring side 10 applies the encrypted parameters and the data, which are transferred back from the information receiving side 20. For example, a network-equipment merchant supplies users uploading some files by Internet explorer. The network-equipment merchant sets a path for uploading. The path can be observed by the network-equipment merchant only. When the users upload the files, they can't observe the path. Herein, the network-equipment merchant is comparative with the information transferring side 10, the users are comparative with the information receiving side 20, the path is comparative with the parameters, the files are comparative with the data.

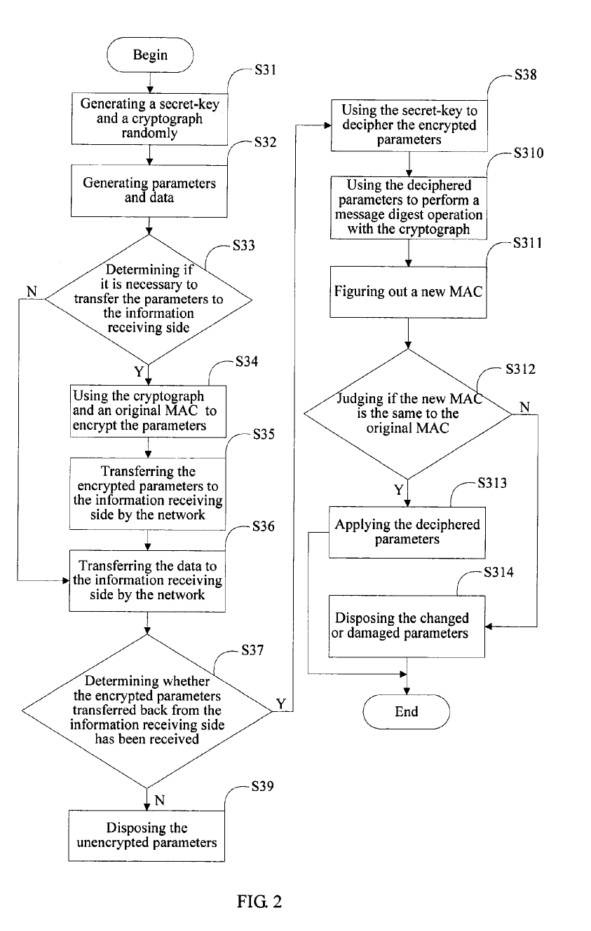

FIG. 2 is a flowchart of a preferred method for transferring parameters by network 30. In step S31, an information transferring side 10 generates a secret-key and a cryptograph randomly. In this embodiment, one secret-key corresponds to one cryptograph. Namely, the information transferring side 10 using one cryptograph to encrypt parameters can only use one secret-key to decipher. In step S32, the information transferring side 10 generates parameters and data, which will be transferred to an information receiving side 20 by network. In step S33, the information transferring side 10 determines if it is necessary to transfer the parameters to the information receiving side 20. In step S34, the information transferring side 10 uses the cryptograph and an original MAC (Massage Authentication Code) to encrypt the parameters, if it is necessary to transfer the parameters to the information receiving side. Herein, an algorithm called AES (Advanced Encryption Standard) is used to encrypt the parameters. The MAC performs a Message digest (Hash, for example, MD5 and SHA1) operation with the cryptograph and the parameters. In step S35, the information transferring side 10 transfers the encrypted parameters to the information receiving side 20 by the network. In step S36, the information transferring side 10 transfers the data to the information receiving side 20 by the network. In step S33, if it is no necessity to transfer the parameters to the information receiving side 20, executes the step S36 firsthand. In step S37, the information transferring side 10 determines whether the encrypted parameters transferred back from the information receiving side 20 has been received. In step S38, the information transferring side 10 uses the secret-key to decipher the encrypted parameters, if the information transferring side 10 receives the encrypted parameters transferred back from the information receiving side 20. Namely, the information transferring side 10 obtains the deciphered parameters by an inverse operation of the encryption by utilizing the parameters, the MAC and the secret-key. In step S39, the information transferring side 10 disposes the unencrypted parameters, if the information transferring side 10 doesn't receive the encrypted parameters transferred back from the information receiving side 20. For example, the information transferring side 10 analyzes the unencrypted parameters, or informs the information receiving side 20 to transfer back the encrypted parameters as quickly as possible. In step S310, the information transferring side 10 uses the deciphered parameters to perform a Message digest operation with the cryptograph. In step S311, the information transferring side 10 figures out a new MAC. In step S312, the information transferring side 10 judges if the new MAC is the same to the original MAC. Herein, if the new MAC is the same to the original MAC, it shows that the encrypted parameters transferred back from the information receiving side 20 are the parameters which is encrypted by the information transferring side 10. If the new MAC is not the same to the original MAC, it shows that the encrypted parameters transferred back from the information receiving side 20 is not the parameters which is encrypted by the information transferring side 10. Maybe the encrypted parameters transferred back from the information receiving side 20 has been changed or damaged. In step S313, the information transferring side 10 applies the deciphered parameters, if the new MAC is the same to the original MAC. For example, the information transferring side 10 modifies the deciphered parameters, or generates new parameters to replace the deciphered parameters. In step S314, the information transferring side 10 disposes the changed or damaged parameters, if the new MAC is not the same to the original MAC. For example, the information transferring side 10 analyzes the changed or damaged parameters, or informs the information receiving side 20 of transferring back the deciphered parameters as quickly as possible.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A method for transferring parameters by network, the method comprising the step of:
generating a secret-key and a cryptograph randomly;
affording an information transferring side for transferring parameters and data;
affording an information receiving side for receiving the parameters and the data;
generating the parameters and the data which will be transferred to the information receiving side by network;
determining if it is necessary to transfer the parameters to the information receiving side;
using the cryptograph and an original MAC (Massage Authentication Code) to encrypt the parameters, if it is necessary to transfer the parameters to the information receiving side;
transferring the encrypted parameters to the information receiving side by the network;
transferring the data to the information receiving side by the network;
determining whether the encrypted parameters transferred back from the information receiving side has been received;
using the secret-key to decipher the encrypted parameters, after receiving the encrypted parameters transferred back from the information receiving side;
using the deciphered parameters to perform a Message digest operation with the cryptograph;
figuring out a new MAC;
judging if the new MAC is the same to the original MAC; and
applying the deciphered parameters, if the new MAC is the same to the original MAC.

2. The method according to claim 1, further comprising the step of: transferring the data to the information receiving side by the network firsthand, if it is no necessity to transfer the parameters to the information receiving side.

3. The method according to claim 1, further comprising the step of: disposing the unencrypted parameters, if not receiving the encrypted parameters transferred back from the information receiving side.

4. The method according to claim 1, further comprising the step of: disposing the changed or damaged parameters, if the new MAC is not the same to the original MAC.
